(19) United States
(12) Patent Application Publication
(10) Pub. No.: US 2026/0366441 A1
(43) Pub. Date: Nov. 19, 2026

(54) CAMSHAFT DEVICE AND COVER MODULE

(71) Applicants: thyssenkrupp Dynamic Components GmbH, Ilsenburg (Harz) (DE); thyssenkrupp AG, Essen (DE)

(72) Inventor: Jens SCHIRMER, Chemnitz (DE)

(73) Assignees: thyssenkrupp Dynamic Components GmbH, Ilsenburg (Harz) (DE); thyssenkrupp AG, Essen (DE)

(21) Appl. No.: 19/677,540

(22) Filed: May 14, 2026

(30) Foreign Application Priority Data
May 15, 2025 (DE) 10 2025 118 919.6

(51) Int. Cl. F01L 1/047; F16H 53/02

(52) U.S. Cl. CPC F01L 1/047; F16H 53/02; F01L 2001/0476; F16C 2360/18

(57) ABSTRACT

A camshaft device comprises a camshaft and at least one bearing device, wherein the bearing device comprises a rolling bearing for rotatably supporting the camshaft and comprises a first bearing holder and a second bearing holder which are configured to clamp the rolling bearing between them, wherein one of the bearing holders is configured as a sheet-metal clip. A cover module or cylinder head has such a camshaft device.

### CROSS REFERENCE TO RELATED APPLICATION

This application is a U.S. Non-Provisional that claims priority to German Patent Application No. DE 10 2025 118 919.6, filed May 15, 2025, the entire content of which is incorporated herein by reference.

### FIELD

The present disclosure relates to a camshaft device, and to a cover module or cylinder head.

### BACKGROUND

Camshafts are generally used to control the gas exchange valves of an engine, and are subject to high mechanical and thermal loads.

The camshaft is for example rotatably supported in a cover module, which supports the camshaft together with bearing arrangement above the cylinder head, or on the cylinder head itself.

The camshaft is generally supported by means of bearing devices, each comprising a rolling bearing, in particular needle-roller bearing, a first bearing holder and a second bearing holder. The bearing holders between them form a mount for the rolling bearing, in which, in turn, the camshaft is rotatably supported. For this purpose, the bearing holders each comprise semicylindrical recesses in which the rolling bearing, in particular the outer ring of the rolling bearing, is received.

The first bearing holder is generally formed by the cover module or by the cylinder head itself, whereas the second bearing holder is mounted, in particular screwed, onto the first bearing holder.

Both the installation of the bearing device and the generally different materials of bearing holders, rolling bearings and camshaft can pose challenges.

The second bearing holder, which is generally formed from aluminium, is formed as a milled shaped part and, in addition to bores for a screw connection, has the aforementioned recess for receiving the rolling bearing. It is clear that it is necessary here to establish a radial form fit with respect to the rolling bearing, in particular the outer ring of the rolling bearing. The recess in the bearing holder must accordingly be precisely adapted to the outer ring. This must be implemented very precisely both in the production process and during the installation of the bearing holder. The production process and the installation process are correspondingly very demanding. For this purpose, the screwed-on bearing holder must be produced in a separate casting tool and, in after the common spindling, paired with the corresponding cylinder head position. The casting tool, mounted spindling and the associated dismounting process for the placement of the camshaft, and the joint handling of the paired components until the camshaft installation stage, are cumbersome and expensive.

Also, the use of aluminium parts in combination with steel components (for example the camshaft or the needle-roller bearing) leads to problems owing to different coefficients of thermal expansion. In order to avoid thermally induced clamping or excessive bearing play, it is necessary to provide large tolerances, in particular in the bearing device. This in turn can lead to undesired NVH (Noise, Vibration, Harshness) effects during the operation of the engine.

In particular in the case of sliding camshafts which have additional axial movement capabilities, increased demands are placed on the bearing geometry and rigidity, absence of friction, and thermal compensation.

Thus a need exists for providing a camshaft device which allows easy and cost-efficient installation, which at the same time exhibits reduced bearing play, and which minimizes thermally induced influences on the bearing function. It is furthermore sought to achieve an improvement in NVH behavior, and to reduce the outlay on manufacturing and installation, through the design of the bearing device.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a camshaft device according to the prior art as part of a cover module, in a perspective view.

FIG. 2 shows a camshaft device according to the prior art as part of a cover module, in an exploded illustration;

FIG. 3 shows a camshaft device according to the prior art as part of a cover module, in a sectional view;

FIG. 4 shows a camshaft device according to the prior art as part of a cover module, in a sectional view together with parts of the valve train of an internal combustion engine;

FIG. 5 shows a camshaft device according to the invention as part of a cover module according to the invention, in a perspective view;

FIG. 6 shows a camshaft device according to the invention as part of a cover module according to the invention, in an exploded illustration;

FIG. 7 shows a camshaft device according to the invention as part of a cover module according to the invention, in a sectional view;

FIG. 8 shows a camshaft device according to the invention as part of a cover module according to the invention, in a sectional view together with an auxiliary element for clamping purposes;

FIG. 9 shows a camshaft device according to the invention as part of a cover module according to the invention, in a sectional view, with a dome of the sheet-metal clip;

FIG. 10 shows a camshaft device according to the invention as part of a cover module according to the invention, in a sectional view, with a segmentation of the sheet-metal clip;

FIG. 11 shows a camshaft device according to the invention, having a sliding camshaft, as part of a cover module according to the invention, in a perspective view;

FIG. 12 shows a camshaft device according to the invention, having a sliding camshaft, as part of a cover module according to the invention, in an exploded illustration;

FIG. 13 is a schematic illustration of a cylinder head according to the invention having a camshaft device according to the invention.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

Some embodiments include a camshaft device. By virtue of one of the bearing holders being configured as a sheet-metal clip, a particularly simple, lightweight and easy-to-install design of the bearing device is provided. The sheet-metal clip may be manufactured as a separate thin-walled component, and replaces conventional bearing caps consisting of aluminium, which require cumbersome machining. It allows frictional, in particular also form-fitting, fixing of the rolling bearing outer ring without itself having to perform load-bearing functions with regard to the forces introduced from the valve train.

This allows a separation of load guidance and fixing, whereby the mechanical demands on the sheet-metal clip are reduced, and design possibilities are expanded. The sheet-metal clip may furthermore consist of a material having a coefficient of thermal expansion similar to that of the rolling bearing component, whereby temperature-induced changes in dimension are minimized, and a more constant bearing play is achieved. The dimensional changes between the bearing outer ring and the bearing holder configured as a sheet-metal clip are smaller. The bearing outer ring and the bearing holder configured as a sheet-metal clip expand approximately equally. This leads to a reduction of friction losses and to an improvement in NVH behaviour.

Furthermore, the modular design as an installable sheet-metal clip allows automated supply in the form of bulk material and reduces the complexity of manufacturing, logistics and installation. As a result, production costs are lowered, and the functional reliability of the bearing arrangement is increased over a broad temperature range.

In one advantageous embodiment of the invention, the sheet-metal clip may have two bores for screw fastening purposes. The sheet-metal clip can thus be screwed to the cover-side bearing holder easily and so as to be secured in position, which assists in achieving precise fixing of the rolling bearing outer ring and play-free support of the camshaft.

In a further advantageous embodiment of the invention, the sheet-metal clip may form-fittingly receive the rolling bearing over a circumferential region of less than 180°. As a result, when the screw connection is tightened, targeted frictional contact with the outer ring of the rolling bearing is established, which prevents undesired co-rotation and ensures permanent, play-free support. In particular, it can be ensured that the sheet-metal clip is installed under preload, and is thus "pulled into shape". The sheet-metal accordingly has the required stiffness only in the tensile direction, and bears closely against the rolling bearing when installed. Dimensional discrepancies between the individual parts are thus equalized during the installation process.

In a further advantageous embodiment of the invention, the first bearing holder may receive the rolling bearing over a circumferential region of less than 180°. This enables the bearing holder to be easily integrated in single-piece form into the cover module, and reduces the outlay on machining, whilst at the same time providing adequate bearing guidance.

In a further advantageous embodiment of the invention, the sheet-metal clip may be provided with at least one auxiliary element which serves to increase the screw clamping length or to increase the axially symmetrical fixing force. The transmission of force from the screw to the bearing region is thus optimized, which increases the stability of the connection and reduces the risk of local deformations. It is furthermore thus possible to create structural space for the screw head.

In a further advantageous embodiment of the invention, the auxiliary element may be configured as a shaped element or as a stamped structure. This allows structurally simple but functionally effective reinforcement of the clamping zone, whereby the bearing arrangement can be made mechanically more robust and durable. Here, a stamped structure is a targetedly plastically deformed geometry which is formed into the sheet-metal component – in this case the sheet-metal clip – by deforming techniques (stamping). Here, the material is not removed, but is formed into a particular shape by pressure. The shaped element is formed here as a separate, rather cylindrical element.

In a further advantageous embodiment of the invention, the sheet-metal clip may be resiliently elastic, wherein the resilient elasticity is achieved in particular through material selection and/or by means of a domed or segmented shape. This allows temperature-independent preloading of the bearing and improves the compensation of tolerances and vibration damping during operation.

In a further advantageous embodiment of the invention, the rolling bearing may comprise an outer ring, and the sheet-metal clip may consist of a material having a coefficient of thermal expansion which corresponds to that of the outer ring. This reduces dimensional changes between the components in the event of temperature fluctuations, and thus prevents temperature-induced loosening or jamming. The dimensional changes between bearing outer ring and sheet-metal clip are smaller, in particular because the bearing outer ring and sheet-metal clip expand approximately equally.

In a further advantageous embodiment of the invention, the rolling bearing may be configured as a needle-roller bearing. Needle-roller bearings make it possible to achieve a compact design with a simultaneously high load-bearing capacity, whereby the invention can be used even in constricted installation spaces.

In a further advantageous embodiment of the invention, the camshaft may be in the form of a sliding camshaft having axially movable cams. The bearing arrangement according to the invention assists in satisfying the requirements on axially displaceable elements, because it allows permanently precise and play-free guidance of the cams.

In a further advantageous embodiment of the invention, the first bearing holder, as cover-side bearing holder, is formed as a single piece with the cover module. This reduces the number of components and the outlay on installation, which has a positive effect on manufacturing time, costs and reliability.

In a further advantageous embodiment of the invention, the sheet-metal clip, as second bearing holder, is arranged exclusively on the load-free side of the rolling bearing. This reduces the requirements on the component with regard to strength and stability, and allows a material-saving and cost-efficient design.

Some embodiments include a cover module having a camshaft device. Such embodiments can make it possible to targetedly utilize the technical and economic advantages of the described camshaft device – in particular the bearing holder configured as a sheet-metal clip – in a cover module.

By virtue of the camshaft device according to the invention being integrated into the cover module, it is possible to provide an assembly which is optimized in terms of structural space, easy to install and of reduced costs, and with which in particular the number of individual parts, the complexity of the installation process and the outlay on machining are reduced.

A particular advantage arises from the fact that the first bearing holder – that is to say the cover-side bearing holder – can be formed as a single piece with the cover module. This allows a materially homogeneous and geometrically precise design of the bearing point, reduces manufacturing tolerances, and avoids additional interfaces.

By means of the combination with a second bearing half configured as a sheet-metal clip, complete play-free fixing of the rolling bearing can be achieved without the need for a solid bearing bracket or an elaborately machined aluminium cap.

In particular in the case of modern cover modules that are already provided as a functional unit for the valve control mechanism, the configuration according to the invention makes it possible to provide a particularly compact design, whilst at the same time achieving a high mechanical load-bearing capacity and high thermal stability of the bearing arrangement. Furthermore, the risk of temperature-induced expansion conflicts between aluminium and steel is reduced, because the bearing forces are introduced targetedly into the rigid cover structure, whilst the sheet-metal clip serves primarily for fixing purposes.

The cover module with integrated camshaft device according to the invention thus contributes to a reduction in structural space, weight and manufacturing costs, and at the same time to an improvement in functional reliability of the bearing arrangement throughout the entire service life of the engine.

Further features and advantages of the present invention will become apparent from the following description of preferred exemplary embodiments with reference to the appended drawings. The subjects and features of the various exemplary embodiments can in principle be combined with one another as desired.

The following reference signs are used in the figures:
H Cover module
V Valve train
Z Cylinder head
F Force
α Circumferential region (angle of wrap) of first bearing holder
β Circumferential region (angle of wrap) of second bearing holder configured as sheet-metal clip
1 Camshaft
2 Bearing device
11 Sliding cam
21 First bearing holder / cover-side or cylinder-head-side bearing holder
22 Second bearing holder / installable bearing holder (prior art)
22´ Bearing holder configured as sheet-metal clip / second bearing holder / installable bearing holder
23 Rolling bearing
221 Bore for screw fastening purposes / screw
222 Auxiliary element
223 Dome
224 Segmentation
231 Outer ring of the rolling bearing

Here, features and details that are described in conjunction with a method self-evidently also apply in conjunction with the device according to the invention and vice versa, such that reference is always or can always be made reciprocally with respect to the disclosure of the individual aspects of the invention. Moreover, any described method according to the invention can be carried out by means of the device according to the invention.

The terminology used herein serves only to describe particular embodiments and is not intended to restrict the disclosure. As used herein, the singular forms “a/an” and “the” are also intended to include the plural forms unless the context clearly indicates otherwise. In addition, it will be clear that the terms “has” and/or “having”, when used in this description, specify the presence of the stated features, integers, steps, operations, elements and/or components, but do not rule out the presence or the addition of one or more other features, integers, steps, operations, elements, components and/or groups thereof. As used herein, the term “and/or” includes any desired element and all combinations of one or more of the associated, listed elements.

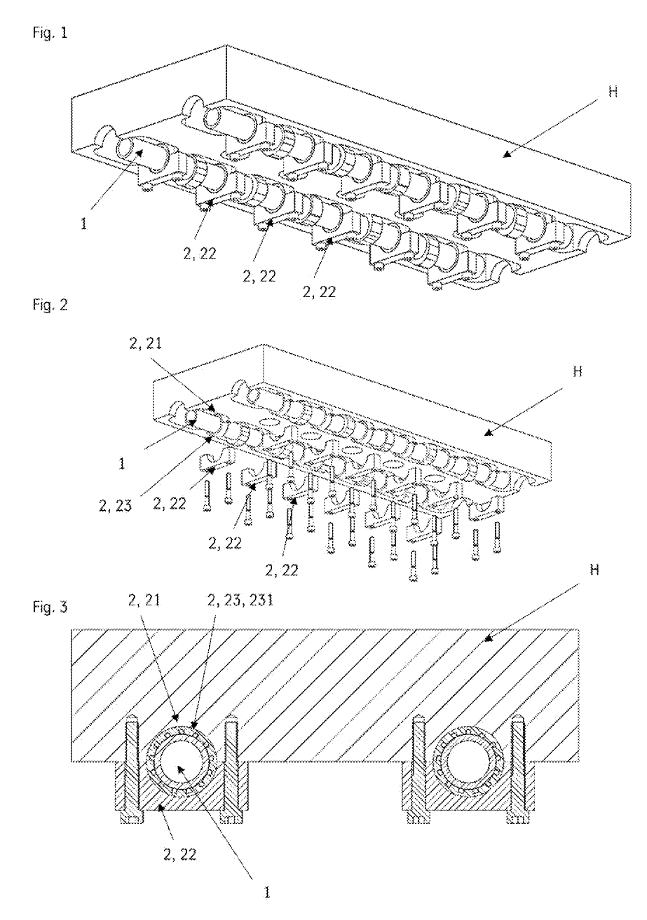

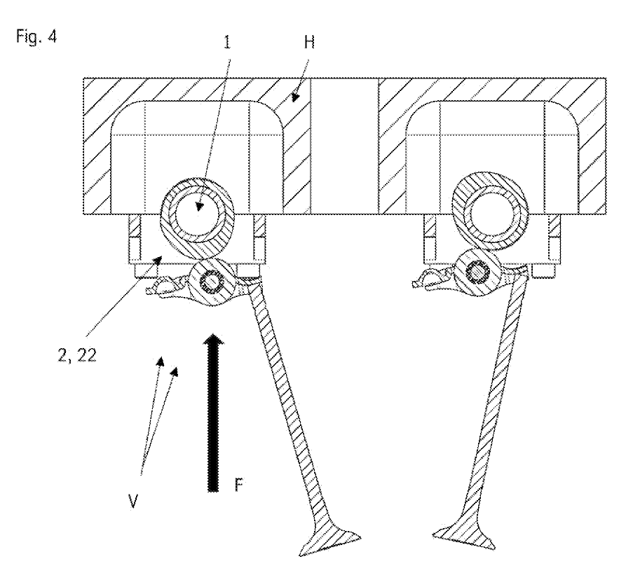

In the following, reference is made to FIGS. 1 - 4.

A camshaft device according to the prior art substantially comprises a camshaft 1 and at least one bearing device 2. The camshaft device preferably comprises a plurality of bearing devices 2 for rotatably supporting the camshaft 1.

The bearing devices 2 are configured to rotatably receive the camshaft 1, for example in a cover module H or on a cylinder head. The differences between a cover module H and a cylinder head are well known to a person skilled in the art. A merely cursory overview will be given below.

A cover module H, also referred to as a "cam carrier", is a component which receives the camshafts 1 together with the bearing arrangement thereof and which is arranged above the cylinder head of an internal combustion engine. Whilst the cylinder head itself closes the combustion chamber, the cover module H performs the functions of supporting the camshafts 1 and integrating the valve train V. By contrast, in the case of a classic cylinder head without a cover module H, the camshafts 1 are supported directly in the cylinder head; the upper closure is implemented that case merely by means of a valve cap.

All of the figures show two camshafts 1 received in a cover module, but this constitutes merely one embodiment. The explanations below will refer to one camshaft.

The bearing device 2 comprises substantially a first bearing holder 21, a second bearing holder 22, and a rolling bearing 23, in particular a needle-roller bearing.

The first bearing holder 21 and the second bearing holder 22 each have a semicylindrical receptacle. The two bearing holders 21, 22 correspondingly form a cylindrical receptacle in which the rolling bearing 23 for the camshaft 1 is received. The camshaft 1 itself is rotatably received in the rolling bearing 23.

The first bearing holder 21 is generally formed by the cover module H or the cylinder head itself. In other words, the first bearing holder 21 is preferably formed as a single piece with the cover module H or cylinder head. To simplify the description, reference will be made below to the cover module H. The arrangement on the cylinder head is in principle the same.

The second bearing holder 22 is generally mounted on and fixed to the first bearing holder 21 by means of two screws, each at the ends of the second bearing holder 22. For easier association, reference will be made below to a cover-side bearing holder 21 and an installable bearing holder 22.

A number of cover-side bearing holders 21 corresponding to the number of required bearing devices 2 for the camshaft 1 are provided on the cover module H. During the installation of the camshaft 1, the camshaft 1 equipped with rolling bearings 23 is placed into the cover-side bearing holders 21. The installable bearing holders 22 are subsequently placed onto the corresponding cover-side bearing holders 21 and fixed by means of the screws. The camshaft 1 is rotatably received in the cover module H.

FIG. 4 illustrates a cover module H having a camshaft device. The rolling bearing 23 is not visible here. It is intended merely to illustrate how the valve train V of an internal combustion engine is arranged relative to the cover module H, in particular the camshaft 1 received therein. It can be seen that the force F to be accommodated by the valve train V is oriented in the direction of the cover module H and thus of the cover-side bearing holder 21.

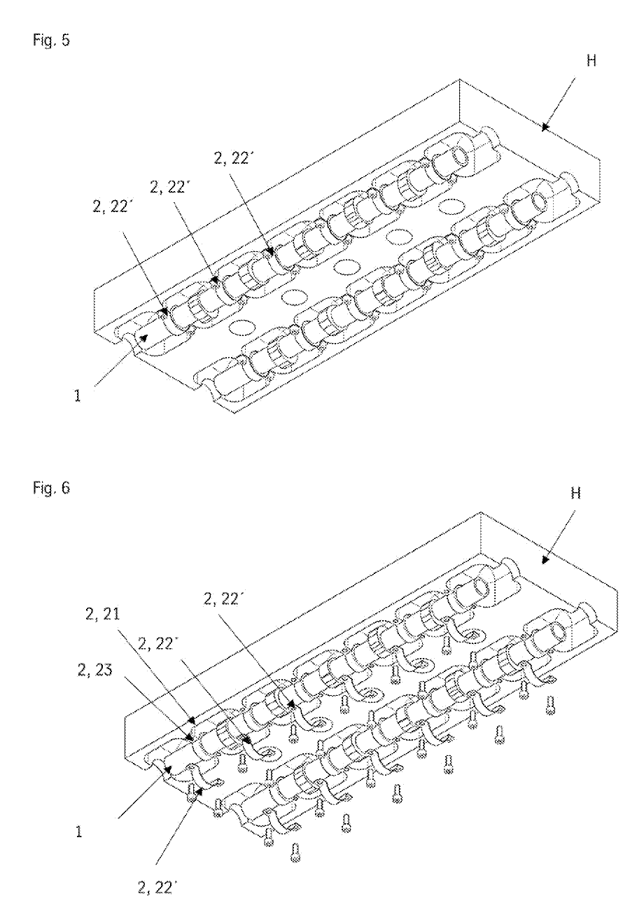

In the following, reference is made to FIGS. 5 - 13. Reference is firstly made in particular to FIGS. 5 - 7.

According to the invention, the camshaft device, in particular the at least one bearing device 2, comprises a bearing holder configured as a sheet-metal clip, in particular an installable bearing holder configured as a sheet-metal clip 22´. In other words, the installable bearing holder 22´ is configured as a sheet-metal clip. For better distinction, the bearing holder configured as a sheet-metal clip is denoted by the reference sign 22´.

The sheet-metal clip 22´ is thus part of the bearing device 2 for receiving the rolling bearing 23, in particular the needle-roller bearing, in which the camshaft 1 is rotatably supported.

The sheet-metal clip 22´ has two bores 221 for screw fastening purposes. The fastening is realized preferably by means of two screws which are arranged in the immediate vicinity of the bearing point in order to achieve a strong clamping action on the outer ring 231 of the needle-roller bearing 23.

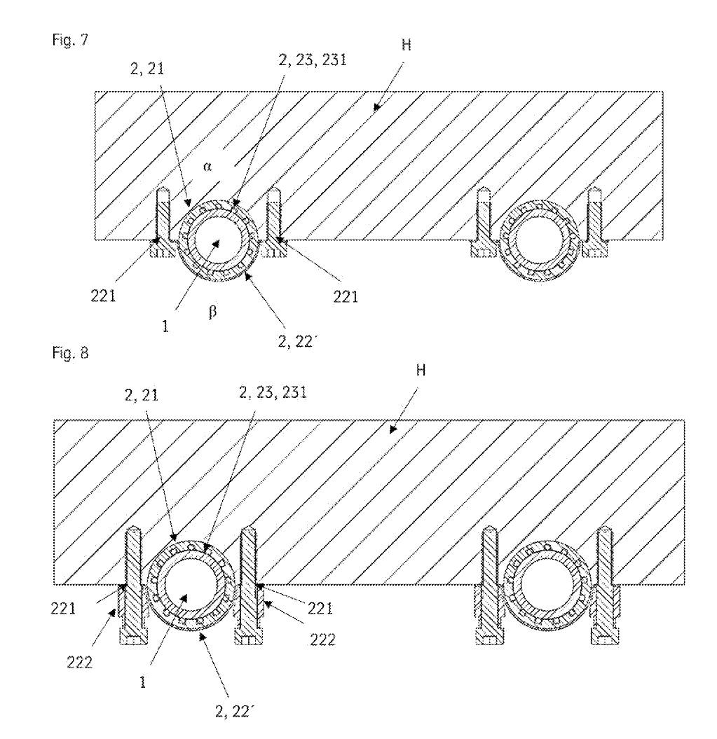

As already discussed above, the cover-side bearing holder 21 receives the outer ring 231 of the rolling bearing 23 over a portion of the circumference, in particular over a circumferential region of at most 180°. For illustrative purposes, the angle is denoted in FIG. 7 by the reference sign α.

The sheet-metal clip 22´ designed as an installable bearing holder is arranged on the opposite side of the cover-side bearing holder 21 and form-fittingly receives the outer ring 231 of the needle-roller bearing 23 likewise over a circumferential region of at most 180°. For illustrative purposes, the angle is denoted in FIG. 7 by the reference sign β. Enclosure of the rolling bearing 23 over 360° can ultimately thus be achieved.

It may however be advantageous here if the sheet-metal clip 22´ covers a circumferential region of less than 180°, because the received outer ring 231 of the rolling bearing 23 can be clamped when the sheet-metal clip 22´ is screwed on.

A further advantage is achieved with regard to manufacture and installation. The sheet-metal clip 22´ is formed as a loose component and can be introduced into the installation process in automated fashion in the form of bulk material. The cumbersome machining and pre-installation of classic aluminium bearing holders can be eliminated entirely. Logistical handling is also simplified because accurately fitting pairing of bearing holders is not required. Furthermore, the changed bearing architecture reduces the need for an active supply of oil, which can contribute to a reduced energy requirement of the oil pump.

The installable bearing holder 22´ configured as a sheet-metal clip can be particularly advantageously integrated into a cover module H, because in this case the sheet-metal clip 22´ does not perform the force-supporting bearing function but rather serves exclusively for securing the needle-roller bearing 23. The load from the valve train is accommodated by the cover-side bearing holder 21, which generally consists of aluminium. The sheet-metal clip 22´ holds the rolling bearing 23 in place merely frictionally, and in particular also form-fittingly in the axial direction. Since load support and fixing are separated, the sheet-metal clip 22´ can be of simple and material-saving design. With regard to the direction of the acting force, reference can be made to the statements relating to FIG. 4. It is however also conceivable in principle for the sheet-metal clip 22´ to be used as an installable bearing holder in a cylinder head or in combined units consisting of cover module and cylinder head. Here, too, it can occur that the force F originating from the valve train does not act directly on the sheet-metal clip, for example because a part of the valve train V is arranged above the camshaft. Use cases are however also conceivable in which a force F from the valve train V acts on the sheet-metal clip. These cases relate predominantly to an arrangement of the bearing device in the cylinder head. The parts involved would then have to be referred to as a cylinder-head-side bearing holder 21 and, once again, an installable bearing holder 22´ configured as a sheet-metal clip.

The boundaries here are fluid, but in order to simplify the description, installation in a cover module will be assumed.

In the following, reference is made in particular to FIG. 8.

It can be seen in FIG. 8 that the sheet-metal clip 22´ may be equipped with two auxiliary elements 222 which improve the clamping action against the outer ring 231 of the rolling bearing 23. The auxiliary element 222 is generally integrated in the vicinity of the screw fastening and serves to increase the effective screw clamping length and to increase the axially symmetrical fixing force. By means of this structural measure, the screw can be positioned closer to the actual bearing point, whereby the load is introduced more directly into the surroundings of the bearing.

The auxiliary element 222 may be a reinforcement portion, a shaped element or a stamped structure which is screwed on together with the sheet-metal clip 22´ and in the process generates a defined clamping fit via the outer ring 231 of the needle-roller bearing 23. Thus, in particular in the case of sliding camshafts involving axial movement, permanently play-free support is made possible without the outer ring 231 co-rotating or axially moving. The design also makes it possible for the required installation force to be distributed over a larger area, which both improves the stress distribution and reduces the risk of local deformations.

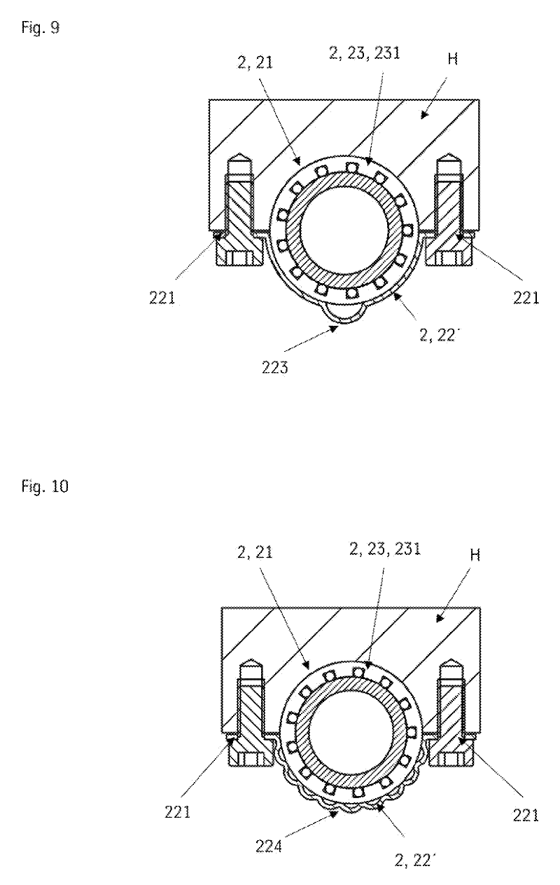

In the following, reference is made in particular to FIGS. 9 and 10 .

The clamping effect may also or additionally be achieved by means of further measures.

For example, the sheet-metal clip 22´ may be of intrinsically resiliently elastic design. The resilient elasticity may for example be achieved or set through the material selection for the sheet-metal clip 22´. The resilient elasticity may also be generated by means of corresponding shaping, for example domed (FIG. 9 – dome 223) or segmented (FIG. 10 – segmentation 224). This resilient form makes it possible for the rolling bearing 23 to be clamped without play or with minimal play, without forming a thermally rigid connection. This is advantageous in particular because the material of the sheet-metal clip 22´ – preferably steel – has a coefficient of thermal expansion which corresponds or is at least approximately adapted to that of the outer ring 231 of the rolling bearing 23. In combination with the cover-side bearing holder 21, which generally consists of aluminium, a temperature-compensated bearing arrangement is thus created. The bearing play can thus be kept constant over a broad temperature range, in particular between −40°C and +140°C.

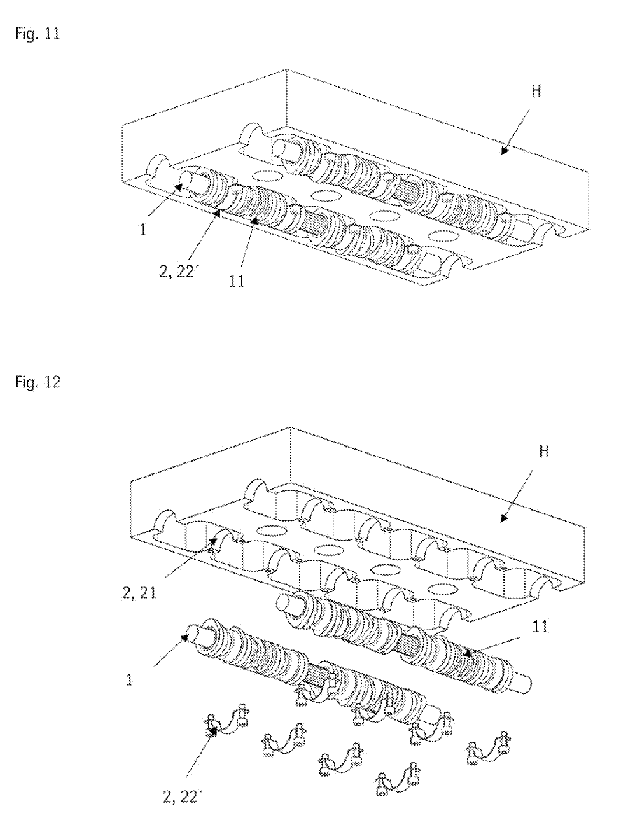

In the following, reference is made in particular to FIGS. 11 and 12 .

The described sheet-metal clip 22´ can be used both in the case of conventional camshafts 1 and in the case of so-called sliding camshafts, that is to say camshafts 1 having axially movable cams 11. In both cases, said sheet-metal clip makes it possible to provide precise, thermally stable and easily installable support for the camshaft 1 by means of a needle-roller bearing in a cover module H or cylinder head.

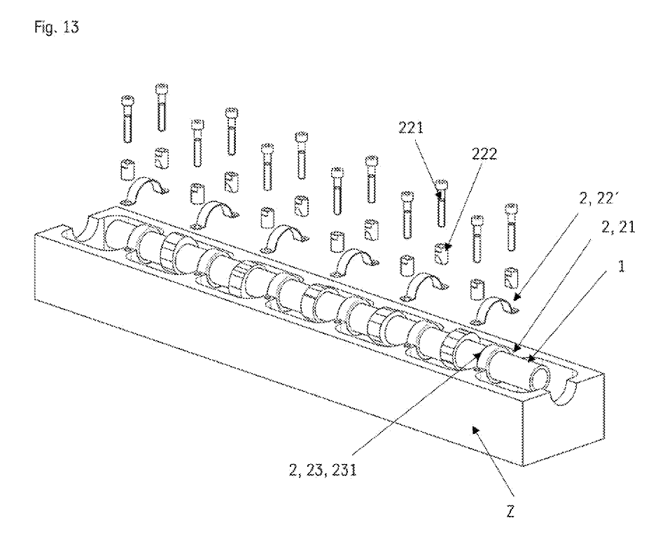

In the following, reference is made in particular to FIG. 13.

FIG. 13 illustrates a cylinder head Z according to the invention having a camshaft device according to the invention. The figure is intended to illustrate that the camshaft device according to the invention can in principle also be installed in a cylinder head Z.

The invention is in principle not limited to the exemplary embodiments outlined above. Rather, variations are conceivable without departing from the concept of the invention, in particular with regard to alternative materials, different geometries for the sheet-metal clip, and changed installation methods or different fields of use.

It is self-evident that only a few selected method steps, such as are helpful for understanding the installation process, have been discussed here. The method may comprise further steps or intermediate steps known to a person skilled in the art. These include the placement of the camshaft together with pre-installed needle-roller bearings, the positioning of the shaft in the cover-side bearing bores, the mounting of the sheet-metal clips with integrated spring element, the fixing of the clips by means of screws, and the checking of the bearing play and of the axial mobility of the sliding cams.

1. A camshaft device, comprising:
a camshaft; and
at least one bearing device;
wherein the bearing device comprises a rolling bearing for rotatably supporting the camshaft and includes a first bearing holder and a second bearing holder which are configured to clamp the rolling bearing between them, wherein one of the bearing holders is configured as a sheet-metal clip.

2. The camshaft device according to claim 1, wherein the sheet-metal clip has two bores for screw fastening purposes.

3. The camshaft device according to claim 1, wherein the sheet-metal clip configured as second bearing holder form-fittingly receives the rolling bearing over a circumferential region of less than 180°.

4. The camshaft device according to claim 1, wherein the first bearing holder receives the rolling bearing over a circumferential region of at most 180°.

5. The camshaft device according to claim 1, wherein the sheet-metal clip is provided with at least one auxiliary element which serves to increase the screw clamping length or to increase the axially symmetrical fixing force.

6. The camshaft device according to claim 5, wherein the auxiliary element is configured as a shaped element or as a stamped structure.

7. The camshaft device according to claim 1, wherein the sheet-metal clip is resiliently elastic, wherein the resilient elasticity is achieved through material selection and/or by means of a domed or segmented shape of the sheet-metal clip.

8. The camshaft device according to claim 1, wherein the rolling bearing comprises an outer ring, wherein the sheet-metal clip consists of a material having a coefficient of thermal expansion which corresponds or is similar to that of the outer ring of the rolling bearing.

9. The camshaft device according to claim 1, wherein the rolling bearing is configured as a needle-roller bearing.

10. The camshaft device according to claim 1, wherein the camshaft is a sliding camshaft having axially movable cams.

11. A cover module or cylinder head having a camshaft device according to claim 1, wherein the first bearing holder is formed as a cover-side or cylinder-head-side bearing holder, and is formed as a single piece with the cover module or cylinder head.

12. The cover module or cylinder head according to claim 11, wherein the sheet-metal clip, as second bearing holder, is arranged exclusively on the load-free side of the rolling bearing.
